(19) United States
(12) Patent Application Publication
(10) Pub. No.: US 2021/0364388 A1
(43) Pub. Date: Nov. 25, 2021

(54) Improved Smith Predictive Controller-Based Aero-engine H-Infinity Algorithm

(71) Applicant: DALIAN UNIVERSITY OF TECHNOLOGY, Dalian, Liaoning (CN)

(72) Inventors: Ximing SUN, Dalian, Liaoning (CN); Xian DU, Dalian, Liaoning (CN); Yanhua MA, Dalian, Liaoning (CN)

(21) Appl. No.: 17/252,545

(22) PCT Filed: Nov. 21, 2019
(86) PCT No.: PCT/CN2019/119831

§ 371 Date: Dec. 15, 2020

(51) Int. Cl. G01M 15/00; G05B 13/04; G06F 30/20

(52) U.S. Cl. CPC G01M 15/00; G05B 13/048; G06F 2119/02; G05B 13/042; G06F 30/20; G05B 13/041

(57) ABSTRACT

The present invention provides an improved Smith predictive controller-based aero-engine H∞ algorithm, and belongs to the technical field of aero-engine control and simulation. The present invention first establishes a reasonable small deviation linear model for an aero-engine nonlinear model, and selects the state space model data of a certain operating condition as the controlled object for controller design; selects appropriate performance index weighting function parameters, solves the H_{∞} output feedback controller, and adjusts the parameters to basically meet the control requirements; and designs a Smith predictive compensator with an improved structure based on a closed-loop feedback control system designed according to the H_{∞} control law to constitute a compound controller, adds a deviation correction controller designed according to the PID control law to the control system to stabilize the controlled object in view that the prediction model and parameters of the controlled object have large deviations from the real model and parameters, and makes adaptive corrections by comparing the output signals of the controlled object and the model so as to further enhance the robustness of the system.

### TECHNICAL FIELD

The present invention provides an improved Smith predictive controller-based aero-engine H∞ algorithm, and belongs to the technical field of aero-engine control and simulation.

### BACKGROUND

The present invention relies on the background of the compensation and control of the distributed network time-delay system of a nonlinear part-level mathematical model of a certain type of twin-shaft turbofan engine.

An aero-engine is a complex multi-variable control system with strong time-variation and strong nonlinearity, and the operational reliability and high efficiency thereof are essential to the safe flight of an aircraft. With the continuous improvement of the design requirements of the aero-engine control system, the centralized control architecture is difficult to meet the complex control requirements. In order to further improve the reliability of the system and reduce weight and cost, the engine distributed control architecture is used more and more widely. The introduction of a network into the aero-engine distributed control system, which is a network control system, will inevitably cause a communication delay between the sensor/executive agency and the controller. Compared with the traditional control system, the application of the network communication technology in control systems has many advantages, but also brings a series of special problems to be urgently researched and solved, among which network induced delay is one of the major problems in the system. Time delay has a great impact on the stability and performance of the control system, and in severe cases, may even lead to system instability. Therefore, the research on the time delay compensation strategy and control method in the aero-engine distributed control system is of great significance.

At present, the analysis and research theory of the network control system at home and abroad is seriously lagging behind the actual application status, especially in the time-delay compensation and stability control of the network control system. According to the existing literature, domestic and foreign researchers propose control methods and solutions from various perspectives for random, time-varying and uncertain network delay: the first is to change the control strategy, regard the network delay as the parameter of the augmented controlled object model, and adopt intelligent control algorithms such as fuzzy and neural networks, but advanced control algorithms are more complex, occupy too much node resources in the network control system, and are difficult to implement in practical application; the second is to reduce the impact of network delay on system stability by improving the communication protocol, but the development of the communication protocol and the approval of the International Organization for Standardization need a long period of time, thus being difficult to apply in a short period of time; and the third is to use the modern measurement and control technology for on-line measurement, estimation or identification of network delay so as to realize the compensation and control of time delay, but the mathematical model of time-delay prediction, estimation or identification is difficult to establish accurately due to the complexity of network delay and cannot meet the time-delay conditions of the traditional Smith predictive controller. So far, no patent discloses an aero-engine distributed network time-delay system compensation and control method with compound control constituted by combining an improved Smith predictive controller and the H∞ control law.

### SUMMARY

In order to ensure the stability of the aero-engine control system and to address the problem of communication delay between the sensor/executive agency and the controller in the network control system, the present invention proposes an improved Smith predictive controller-based aero-engine H∞ algorithm.

The technical solution of the present invention is:

An improved Smith predictive controller-based aero-engine H∞ algorithm, wherein the controller part in the closed loop of the control system used in the aero-engine H∞ algorithm comprises two parts: the first part is a controller designed with the H∞ control strategy, mainly completing the tracking control on the controlled variable of an aero-engine; and the second part is a time-delay compensation strategy using the improved Smith predictive controller, solving the problem of insufficient adaptability of the aero-engine controller designed according to the H∞ control strategy to the time delay phenomenon.

An improved Smith predictive controller-based aero-engine H∞ algorithm, comprises the following steps:

S1. Acquiring the Linear Model of an Aero-Engine Under a Certain Operating Condition

The engine model is the design basis of the control system. First of all, establishing a reasonable linear model for the aero-engine nonlinear model; based on a multi-variable control target, selecting a high pressure rotor speed and a turbo pressure ratio as controlled variables; the controlled quantities corresponding to the controlled variables are respectively fuel oil and exhaust nozzle area; and the small deviation linear model of the aero-engine under a certain operating condition is expressed by the following state space equation:

$$[ \begin{matrix}Δ {\dot{x}}_{1} \\ Δ {\dot{x}}_{2}\end{matrix} ] = A [ \begin{matrix}Δ {x}_{1} \\ Δ {x}_{2}\end{matrix} ] + B [ \begin{matrix}Δ {W}_{f} \\ Δ {A}_{8}\end{matrix} ] [ \begin{matrix}Δ {N}_{2} \\ Δ PiT\end{matrix} ] = C [ \begin{matrix}Δ {x}_{1} \\ Δ {x}_{2}\end{matrix} ] + D [ \begin{matrix}Δ {W}_{f} \\ Δ {A}_{8}\end{matrix} ] \qquad ( 1 )$$

wherein Δx=[Δx₁ Δx₂]^{T} is a state variable, and Δ\dot{x}=[Δ\dot{Δ}₁ Δ\dot{x}₂]^{T} is a derivative corresponding to the state variable; Δu=[ΔWⱼ ΔA_{S}]^{T} is a controlling action (input quantity of an controlled object), ΔW_{f} is an fuel oil increment output by the controller, and ΔA₈ is an exhaust nozzle area increment; Δy=[ΔN₂ ΔPiT]^{T} is a system output quantity, and ΔN₂ and ΔPiT are respectively the high pressure rotor speed and the turbo pressure ratio; A, B, C, D are engine linear model parameter matrices; and the system identification toolbox provided by Matlab is used to identify a nonlinear model of a certain type of twin-shaft turbofan engine to acquire the small deviation linear model of the engine.

S2. Designing a Multi-Variable H∞ Controller for the Aero-Engine Nonlinear Model

According to the design principle of the multi-variable H∞ controller, selecting appropriate performance index weighting function parameters, solving the output feedback controller, and adjusting the parameters to meet the control requirements; conducting a multi-variable nonlinear controller test, and finely adjusting each parameter to ensure the overall effect of the turbofan engine so as to enhance the robustness of the multi-variable control system of the turbofan engine;

S2.1. Selecting the small deviation linear model acquired through system identification as the nominal model, and regarding the models at other points in the flight envelope as perturbations relative to the nominal model;

S2.2. Selecting an appropriate weighting function according to the steady-state control requirements, dynamic control requirements and robustness requirements of engine control indexes. The relationship between the weighting function and the control design indexes is described as follows:

$$\begin{matrix}\overline{σ} ( S ( s ) ) \leq \overline{σ} [ {W}_{s}^{- 1} ( s ) ] & ( 2 ) \\ \overline{σ} ( R ( s ) ) \leq \overline{σ} [ {W}_{R}^{- 1} ( s ) ] & ( 3 ) \\ \overline{σ} ( T ( s ) ) \leq \overline{σ} [ {W}_{T}^{- 1} ( s ) ] & ( 4 )\end{matrix}$$

wherein

$$S ( s ) = \frac{e ( s )}{r ( s )} = {( I + G ( s ) )}^{- 1}$$

is the sensitivity function of the control system;

$$T ( s ) = \frac{y ( s )}{r ( s )} = G ( s ) {( I + G ( s ) )}^{- 1} = I - S ( s )$$

is the complementary sensitivity function of the system;

$$R ( s ) = \frac{u ( s )}{r ( s )} = K ( s ) S ( s ) = K ( s ) {( I + G ( s ) )}^{- 1} ,$$

and ∥R(s)∥_{∞} is usually used to measure the additive perturbations of the system; Wₛ(s) is the performance weighting function; W_{R}(s) is the controller output weighting function; W_{T}(s) is the robust weighting function; G(s) is the original controlled object; and K(s) is the controller;

S2.3. Establishing an augmented controlled object in the following forms:

\dot{x}=Ax+B₁w+B₂u

y=C₁x+D₁₁w+D₁₂u

z=C₂x+D₂₁w+D₂₂u (5)

wherein A, B₁, B₂, C₁, C₂, D₁₁, D₁₂, D₂₁, D₂₂ are model parameter matrices of the augmented controlled object, u is the controlling action (input quantity of the controlled object), w is the external disturbance, Y is the system measurement output signal, and z is the evaluation signal, generally including tracking error, adjustment error and executive agency output.

The augmented controlled object can be expressed as follows:

$$P = [ \begin{matrix}{W}_{s} & - {W}_{s} G \\ 0 & {W}_{R} \\ 0 & {W}_{T} G \\ I & - G\end{matrix} ] = [ \begin{matrix}A & {B}_{1} & {B}_{2} \\ {C}_{1} & {D}_{11} & {D}_{12} \\ {C}_{2} & {D}_{21} & {D}_{22}\end{matrix} ] \qquad ( 6 )$$

wherein P is the augmented controlled object; G is the original controlled object; and Wₛ, W_{R} and W_{T} are respectively the performance weighting function, the controller output weighting function, and the robust weighting function.

S2.4. After constituting the augmented controlled object, selecting appropriate parameters according to the index requirements of the control system, and solving the controller to obtain the Hoc mixed sensitivity controller. The performance indexes meeting the H∞ mixed sensitivity control problem are:

min∥T_{zw}(s)∥_{∞}<γ₀(H_{∞} mixed sensitivity optimal control problem) (7)

∥T_{zw}(s)∥_{∞}<γ(H_{∞} mixed sensitivity suboptimal control problem) (8)

wherein T_{zw}(s) is the closed-loop transfer function of the system from external input w to controlled output z; and γ₀,γ are the given values and γ>min∥T_{zw}(s)∥_{∞};

If γ that is not 1 is included in each weighting function, transforming the aero-engine H∞ controller into the standard H∞ control:

$${‖ \begin{matrix}{W}_{s} ( s ) S ( s ) \\ {W}_{R} ( s ) R ( s ) \\ {W}_{T} ( s ) T ( s )\end{matrix} ‖}_{∞} \leq 1 \qquad ( 9 )$$

S2.5. Building control system simulation based on the engine linear model, and adjusting the performance index weighting function parameters to basically meet the control index requirements to keep the system in closed-loop stability;

S2.6. Conducting a multi-variable nonlinear controller test, and finely adjusting each parameter to ensure the overall effect of the turbofan engine so as to enhance the robustness of the multi-variable control system of the turbofan engine;

S3. Designing the Smith Predictive Controller with an Improved Structure

According to the basic principle of the Smith predictive controller, based on a closed-loop feedback system designed according to the H∞ control law, designing the Smith predictive controller with an improved structure to constitute a compound controller, and eliminating the exponential term of the network delay that affects the stability of the system from the closed-loop characteristic equation of the system to realize the predictive compensation for the system network-induced delay, enhance the stability of the system and eliminate the need for on-line measurement of the system delay; and in view that the prediction model and parameters of the controlled object have large deviations from the real model and parameters, adding a controller used to stabilize the controlled object to the control system, and making adaptive corrections by comparing the output signals of the controlled object and the model so as to further enhance the robustness of the system;

S3.1. According to the typical structure of the aero-engine distributed control system, analyzing the transfer function of the closed-loop feedback system, and further analyzing the closed-loop characteristic equation;

closed-loop transfer function:

$$\frac{Y ( s )}{R ( s )} = \frac{K ( s ) {e}^{- {τ}_{co} s} G ( s )}{1 + K ( s ) {e}^{- {τ}_{co} s} G ( s ) {e}^{- {τ}_{sc} s}} \qquad ( 10 )$$

closed-loop characteristic equation:

1+K(s)e^{-τ}^{_{co}}^{s}G(s)e^{-τ}^{_{oc}}^{s}=0

wherein Y(s) is the system measurement output signal, and R(s) is the reference input signal; K(s) is the controller, and G(s) is the controlled object; and τ_{co} and τ_{oc} respectively represent the network delay of the signal from the sensor to the controller and from the controller to the executor.

S3.2. In view of the inaccuracy of the random and uncertain network delay prediction model, adding some parallel or series links in different positions to make compensation, and under certain conditions, excluding the exponential term of the network delay from the closed-loop characteristic equation;

S3.3. In view that the prediction model and parameters of the controlled object have large deviations from the real model and parameters, regarding the difference between the controlled object and the model as the gain error, making adaptive corrections to model gain by comparing the output signals of the controlled object and the model, and designing a field deviation correction controller for stabilizing the controlled object so as to improve the control performance quality;

S3.4. Conducting a compound controller test of an aero-engine time-delay system, finely adjusting each parameter to ensure the speed tracking control effect of the engine to enhance the robustness of the multi-variable control system of the engine and the effectiveness of compensation for time delay.

The steps of acquiring the linear model of an aero-engine under a certain operating condition are as follows:

S1. Saving the data of fuel oil flow and exhaust nozzle area and the corresponding data of high pressure rotor speed and turbo pressure ratio obtained by a certain type of twin-shaft turbofan engine under closed-loop control action;

S2. Using the saved data of fuel oil flow and exhaust nozzle area as the input of the nonlinear part-level simulation model of the engine, providing a step signal as an excitation signal to obtain the output of the engine, and using the relevant output parameters as the input and output data for system identification after data processing;

S3. Based on the Matlab system identification toolbox, importing the input and output data, setting the data name, start time and sampling interval, then removing the average value, selecting the valid range for the input and output data, and selecting the model and the identification method to identify the target system;

S4. Analyzing the system identification error, verifying the acquired model, and selecting the model that best matches the system characteristics.

The present invention has the following beneficial effects:

(1) The present invention provides a new and more effective control idea for the network delay compensation and control of an aero-engine distributed control system, which combines the H∞ algorithm and the Smith predictive compensation method, and establishes an improved Smith predictive controller on the basis of meeting the steady-state control requirements, tracking control requirements and disturbance rejection performance requirements of an aero-engine so as to reduce the impact of time delay and ensure that the aero-engine can still achieve better steady-state performance and dynamic performance under a certain range of random time delay.

(2) In the improved Smith predictive controller-based aero-engine H∞ algorithm provided by the present invention, no predictive compensation model for network delay occurs in the closed-loop feedback control system, which can ensure that the system meets the time-delay conditions of the improved Smith predictive compensation, eliminating the measurement, estimation or identification of random, time-varying and uncertain network delay, and the improved Smith predictive compensation scheme with dual controllers can be used to enhance the robustness and disturbance rejection ability of the system.

(3) The method is also applicable to the design of the control systems of gas turbines with a similar structure and internal combustion engines with a similar working principle, and the application range is wide.

### DESCRIPTION OF DRAWINGS

FIG. 1 is a structural diagram of an aero-engine closed-loop control system with time delay.

FIG. 2 is a design flow chart of an improved Smith predictive controller-based aero-engine H∞ algorithm.

FIG. 3 is a flow chart of acquiring an aero-engine linear model.

FIG. 4 is a design flow chart of an H∞ controller.

FIG. 5 is a two-terminal structural block diagram of an augmented system of an H∞ controller.

FIG. 6 is a design flow chart of an improved Smith predictive compensator.

FIG. 7 is a diagram of the compound control structure of an improved Smith predictive controller and the H∞ control law.

FIG. 8 is a diagram of the compound control structure of an improved Smith predictive controller with dual controllers and the H∞ control law.

FIG. 9(a) is an effect diagram of the speed tracking control of an aero-engine under the condition of 0.5 s time delay.

FIG. 9(b) is an effect diagram of the speed tracking control of an aero-engine under the condition of 0.7 s time delay.

FIG. 10(a) is an effect diagram of the turbo pressure ratio tracking control of an aero-engine under the condition of 0.5 s time delay.

FIG. 10(b) is an effect diagram of the turbo pressure ratio tracking control of an aero-engine under the condition of 0.7 s time delay.

FIG. 11 is an effect diagram of the speed disturbance rejection of an aero-engine.

FIG. 12 is an effect diagram of the turbo pressure ratio disturbance rejection of an aero-engine.

### DETAILED DESCRIPTION

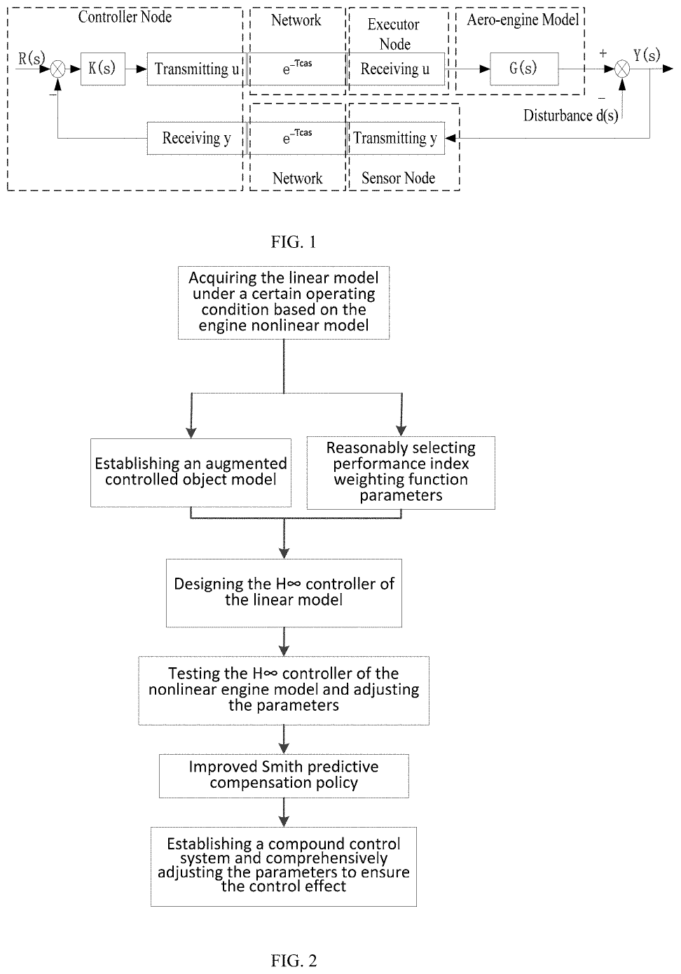

Specific embodiments of the present invention are further described below in combination with accompanying drawings and the technical solution. The present invention relies on the background of the compensation and control of the time-delay system of a certain type of twin-shaft turbofan engine, and the structure of the network time-delay system is shown in FIG. 1.

As shown in FIG. 2, the specific detailed design steps of the improved Smith predictive controller-based aero-engine H∞ algorithm are as follows:

S1. Acquiring the Linear Model of an Aero-Engine Under a Certain Operating Condition

The engine model is the design basis of the control system. First of all, establishing a reasonable linear model for the aero-engine nonlinear model. Based on a multi-variable control target, selecting a high pressure rotor speed and a turbo pressure ratio as controlled variables; and the controlled quantities corresponding to the controlled variables are respectively fuel oil and exhaust nozzle area. The small deviation linear model of the aero-engine under a certain operating condition can be expressed by the following state space equation:

$$[ \begin{matrix}Δ {\dot{x}}_{1} \\ Δ {\dot{x}}_{2}\end{matrix} ] = A [ \begin{matrix}Δ {x}_{1} \\ Δ {x}_{2}\end{matrix} ] + B [ \begin{matrix}Δ {W}_{f} \\ Δ {A}_{8}\end{matrix} ] [ \begin{matrix}Δ {N}_{2} \\ Δ PiT\end{matrix} ] = C [ \begin{matrix}Δ {x}_{1} \\ Δ {x}_{2}\end{matrix} ] + D [ \begin{matrix}Δ {W}_{f} \\ Δ {A}_{8}\end{matrix} ] \qquad ( 1 )$$

wherein Δx=[Δx₁ Δx₂]^{T} is a state variable, and Δ\dot{x}[Δ\dot{x}₁ Δ\dot{x}₂]^{T} is a derivative corresponding to the state variable; Δu=[Δw_{f} ΔA₈]^{T} is a controlling action (input quantity of an controlled object), ΔW_{f} is an fuel oil increment output by the controller, and ΔA₈ is an exhaust nozzle area increment; Δy=[ΔN₂ ΔPiT]^{T} is a system output quantity, and ΔN₂ and ΔPiT are respectively the high pressure rotor speed and the turbo pressure ratio; and A, B, C, D are engine linear model parameter matrices. The system identification toolbox provided by Matlab is used to identify a nonlinear model of a certain type of twin-shaft turbofan engine to acquire the small deviation linear model of the engine.

S2. Designing a Multi-Variable H∞ Controller for the Aero-Engine Nonlinear Model

According to the design principle of the H∞ controller, selecting appropriate performance index weighting function parameters, solving the H∞ output feedback controller, and adjusting the parameters to basically meet the control requirements. Conducting a multi-variable nonlinear controller test, and finely adjusting each parameter to ensure the overall effect of the turbofan engine so as to enhance the robustness of the multi-variable control system of the turbofan engine.

S3. Designing the Smith Predictive Controller with an Improved Structure

According to the basic principle of the Smith predictive controller, based on a closed-loop feedback system designed according to the H∞ control law, designing the Smith predictive controller with an improved structure to constitute a compound controller, and eliminating the exponential tem of the network delay that affects the stability of the system from the closed-loop characteristic equation of the system, which can realize the predictive compensation for the system network-induced delay, enhance the stability of the system and eliminate the need for on-line measurement of the system delay; and in view that the prediction model and parameters of the controlled object have large deviations from the real model and parameters, adding a controller used to stabilize the controlled object to the control system, and making adaptive corrections to model gain by comparing the output signals of the controlled object and the model so as to further enhance the robustness of the system.

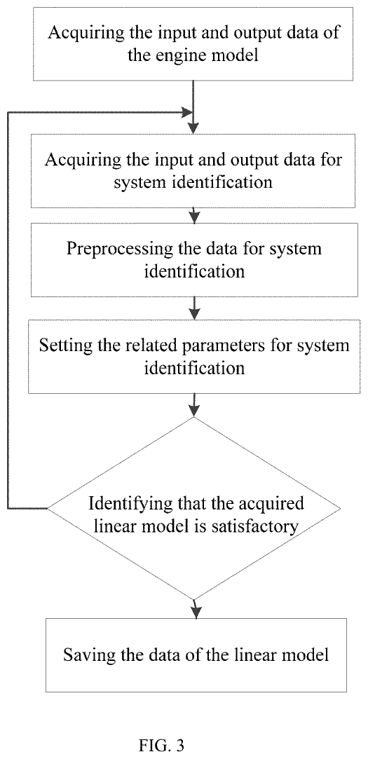

As shown in FIG. 3, the specific steps of acquiring the linear model of an aero-engine under a certain operating condition are as follows:

S1. Saving the data of fuel oil flow and exhaust nozzle area and the corresponding high pressure rotor speed, turbo pressure ratio and other relevant data obtained by a certain type of twin-shaft turbofan engine under closed-loop control action;

S2. Using the saved data of fuel oil flow and exhaust nozzle area as the input of the nonlinear part-level simulation model of the engine, providing a certain step signal as an excitation signal, setting the step signal amplitude at the fuel oil input terminal to 1000 and the step signal variation at the exhaust nozzle area input terminal to 100, and saving the output data of the engine. Performing data processing on the relevant output parameters, and removing the steady-state parameters of the design point to obtain deviation data relative to the steady-state point data, which can be used as the input and output data for system identification;

S3. Based on the Matlab system identification toolbox, importing the input and output data, setting the data name and start time, setting the sampling interval to 0.025 s, and then conducting data preprocessing; since the excitation signal only works at a certain time T, deleting the input data within the time [0, T], and only retaining the valid input and output data after the time T as the model identification data source. Selecting the state space model identification, specifying the state space order to 2, and using the subspace identification method to identify the target system;

S4. Analyzing the system identification error, verifying the acquired model, regarding the data of fuel oil flow and exhaust nozzle area saved in S1 respectively as the input of the engine nonlinear model and the input of the identified engine small deviation linear model, comparing and analyzing the goodness of fit between the response curves of the output high pressure rotor speed and the turbo pressure ratio of the model, and selecting the model that best matches the system characteristics.

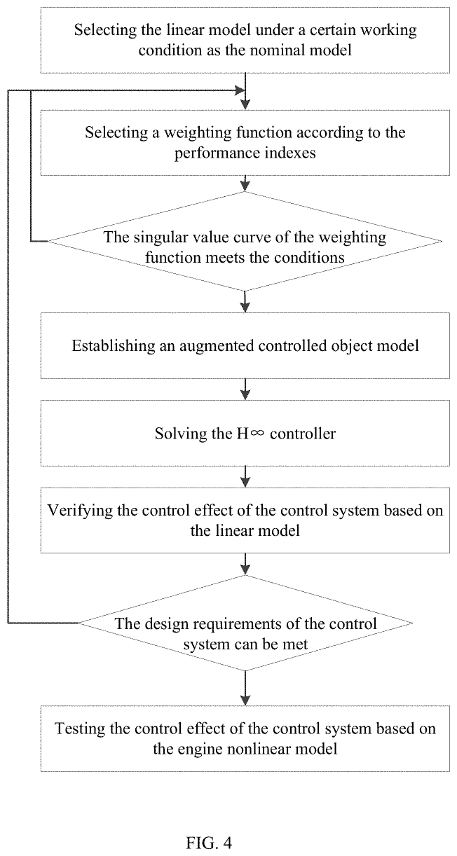

As shown in FIG. 4, the specific steps of designing a multi-variable H∞ controller for the aero-engine nonlinear model are as follows:

S1. Selecting the small deviation linear model acquired through system identification as the nominal model, and regarding the models at other points in the flight envelope as perturbations relative to the nominal model;

S2. Selecting an appropriate weighting function according to the steady-state control requirements, dynamic control requirements and robustness requirements of engine control indexes. The relationship between the weighting function and the control design indexes is described as follows:

σ̅(S(s))≤σ̅[W_{S}⁻¹(s)] (2)

σ̅(R(s))≤σ̅[W_{R}⁻¹(s)] (3)

σ̅(T(s))≤σ̅[W_{T}⁻¹(s)] (4)

wherein

$$S ( s ) = \frac{e ( s )}{r ( s )} = {( I + G ( s ) )}^{- 1}$$

is the sensitivity function of the control system;

$$T ( s ) = \frac{Y ( s )}{r ( s )} = G ( s ) {( I + G ( s ) )}^{- 1} = I - S ( s )$$

is the complementary sensitivity function of the system;

$$R ( s ) = \frac{u ( s )}{r ( r )} = K ( s ) S ( s ) = K ( s ) {( I + G ( s ) )}^{- 1} ,$$

and ∥R(s)∥ₓ is usually used to measure the additive perturbations of the system; Wₛ(s) is the performance weighting function; W_{R}(s) is the controller output weighting function; W_{T}(s) is the robust weighting function; and G(s) is the original controlled object; and K(s) is the controller.

Analyzing the singular value curve of the weighting function, and finally selecting the weighting function that meets the design requirements of the performance indexes as follows:

$$\begin{matrix}{W}_{s} ( s ) = [ \begin{matrix}\frac{001 s + 0.01}{s + 0.0001} & 0 \\ 0 & \frac{001 s + 0.01}{s + 0.0001}\end{matrix} ] & ( 5 ) \\ {W}_{R} ( s ) = [ \begin{matrix}0.000009 & 0 \\ 0 & 0.000 \; 009\end{matrix} ] & ( 6 ) \\ {W}_{T} ( s ) = [ \begin{matrix}\frac{0.0001 s + 1 e - 09}{0.01 s + 0.01} & 0 \\ 0 & \frac{00001 s + 1 e - 09}{001 s + 0.01}\end{matrix} ] & ( 7 )\end{matrix}$$

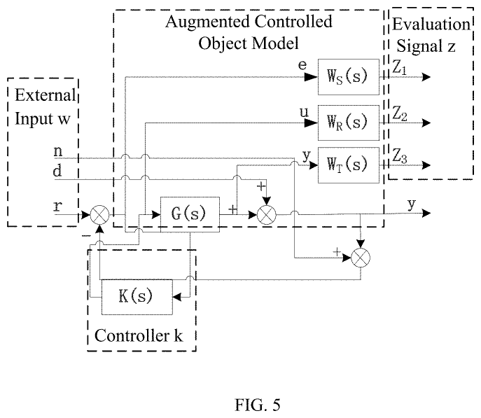

S3. Establishing an augmented controlled object (FIG. 5) in the following forms:

\dot{x}=Ax+B₁w+B₂u

y=C₁x+D₁₁w+D₁₂u

z=C₂x+D₂₁w+D₂₂u (8)

wherein A, B₁, B₂, C₁, C₂, D₁₁, D₁₂, D₂₁, D₂₂ are model parameter matrices of the augmented controlled object, u is the controlling action (input quantity of the controlled object), w is the external disturbance signal, y is the system measurement output signal, and z is the evaluation signal, generally including tracking error, adjustment error and executive agency output.

The augmented controlled object can be expressed as follows:

$$P = [ \begin{matrix}{W}_{s} & - {W}_{s} G \\ 0 & {W}_{R} \\ 0 & {W}_{T} G \\ I & - G\end{matrix} ] = [ \begin{matrix}A & {B}_{1} & {B}_{2} \\ {C}_{1} & {D}_{11} & {D}_{{ }^{12}} \\ {C}_{2} & {D}_{21} & {D}_{22}\end{matrix} ] \qquad ( 9 )$$

wherein P is the augmented controlled object; G is the original controlled object; and Wₛ, W_{R} and W_{T} are respectively the performance weighting function, the controller output weighting function, and the robust weighting function.

S4. After constituting the augmented controlled object, solving the controller to obtain the H∞ mixed sensitivity controller. The performance indexes meeting the H∞ mixed sensitivity control problem are:

min∥T_{zw}(s)∥_{∞}<γ₀(H_{∞} mixed sensitivity optimal control problem) (10)

∥T_{zw}(s)∥_{∞}<γ (H_{∞} mixed sensitivity suboptimal control problem) (11)

wherein T_{zw}(s) is the closed-loop transfer function of the system from external input w to controlled output z; and γ₀,γ are the given values and γ>min∥T_{zw}(s)∥_{∞}.

If γ that is not 1 is included in each weighting function, transforming the aero-engine H∞ controller into the standard H∞ control:

$${‖ \begin{matrix}{W}_{s} ( s ) S ( s ) \\ {W}_{R} ( s ) R ( s ) \\ {W}_{T} ( s ) T ( s )\end{matrix} ‖}_{∞} \leq 1 \qquad ( 12 )$$

Selecting appropriate parameters according to the index requirements of the control system, and reasonably setting the input parameters of the H∞ controller solution function hinfsyn( ), wherein the accuracy is set to 0.001, and the range of performance index γ is (0.5, 20);

S5. Building control system simulation based on the engine linear model, and adjusting the performance index weighting function parameters to basically meet the control index requirements to keep the system in closed-loop stability;

S6. Conducting a multi-variable nonlinear controller test, and finely adjusting each parameter to ensure the overall effect of the turbofan engine so as to enhance the robustness of the multi-variable control system of the turbofan engine.

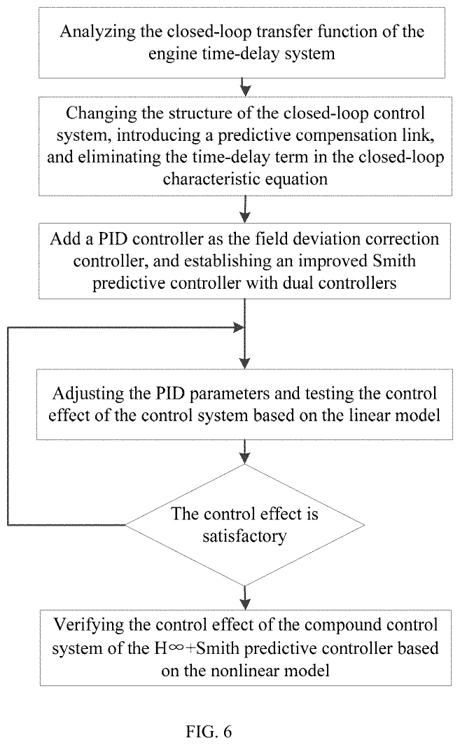

As shown in FIG. 6, the specific steps of designing the Smith predictive controller with an improved structure are as follows:

S1. According to the typical structure of the aero-engine distributed control system, analyzing the transfer function of the closed-loop feedback system, and further analyzing the closed-loop characteristic equation;

closed-loop transfer function:

$$\frac{Y ( s )}{R ( s )} = \frac{K ( s ) {e}^{- {τ}_{ca} S} G ( s )}{1 + K ( s ) {e}^{- {τ}_{ca} S} G ( s ) {e}^{- {τ}_{sc} S}} \qquad ( 13 )$$

closed-loop characteristic equation:

1+K(s)e^{-τ}^{_{ca}}^{s}G(s)e^{-τ}^{_{sc}}^{s}=0 (14)

wherein Y(s) is the system measurement output signal, and R(s) is the reference input signal; K(s) is the controller, and G(s) is the controlled object; and τ_{ca} and τ_{sc} respectively represent the network delay of the signal from the sensor to the controller and from the controller to the executor. The basic principle of Smith predictive compensation is to introduce a predictive compensation link in the aero-engine closed-loop feedback control system so that the closed-loop characteristic equation of the system does not contain a time-delay term and the control performance quality of the whole system is improved.

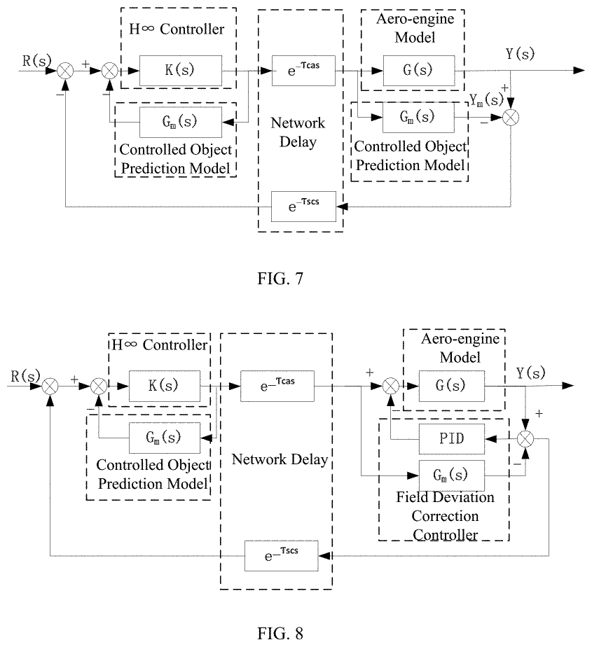

S2. In view of the inaccuracy of the random and uncertain network delay prediction model, the compound control structure of the improved Smith predictive controller and the H∞ control law is shown in FIG. 7, some compensation links are added to the position of the link of the controller and the controlled object, and the closed-loop transfer function of the system after compensation is:

$$\frac{Y ( s )}{R ( s )} = \frac{K ( s ) {e}^{- {τ}^{ca} S} G ( s )}{1 + K ( s ) {G}_{m} ( s ) + K ( s ) {e}^{{e}^{- {τ}^{ca} S}} ( G ( s ) - {G}_{m} ( s ) ) {e}^{- {τ}^{sc} S}} \qquad ( 15 )$$

wherein Gₘ(s) is the prediction model of the original controlled object G(s).

It can be seen from the above formula that when the controlled object prediction model is equivalent to the actual model, the closed-loop characteristic equation no longer contains the exponential term of the network delay;

S3. In view that the prediction model and parameters of the controlled object have large deviations from the real model and parameters, regarding the difference between the controlled object and the model as the gain error, and making adaptive corrections by comparing the output signals of the controlled object and the model. The compound control structure of an improved Smith predictive controller with dual controllers and the H control law is shown in FIG. 8. Designing a field deviation correction controller according to the PID control law for stabilizing the controlled object so as to improve the control performance quality;

S4. Conducting a compound controller test of an aero-engine time-delay system, finely adjusting each parameter to ensure the speed tracking control effect of the engine to enhance the robustness of the multi-variable control system of the engine and the effectiveness of compensation for time delay.

In order to further illustrate the effect of the improved Smith predictive controller-based aero-engine H∞ algorithm in the embodiment, two sets of simulation experiments are conducted to verify the effectiveness of the method in the present invention.

(1) Control Effects Under Different Time-Delay Conditions

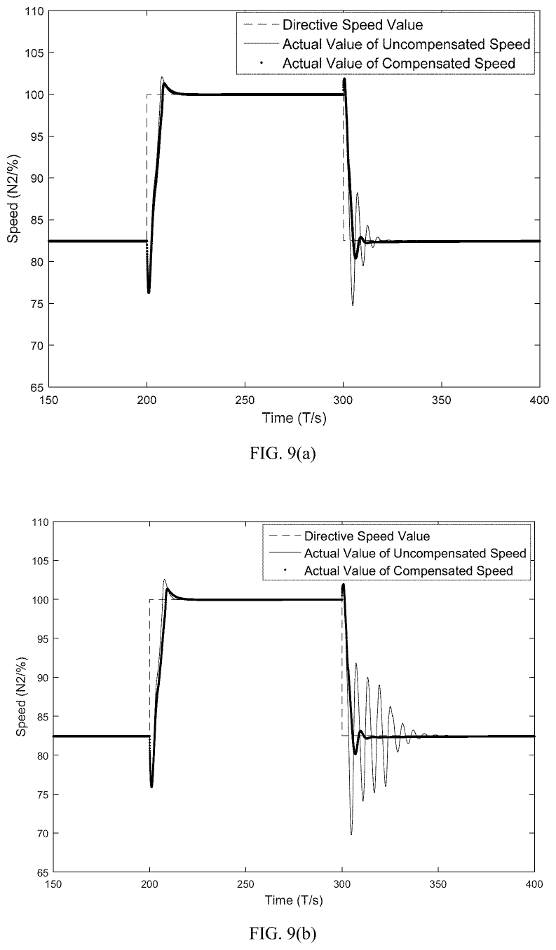

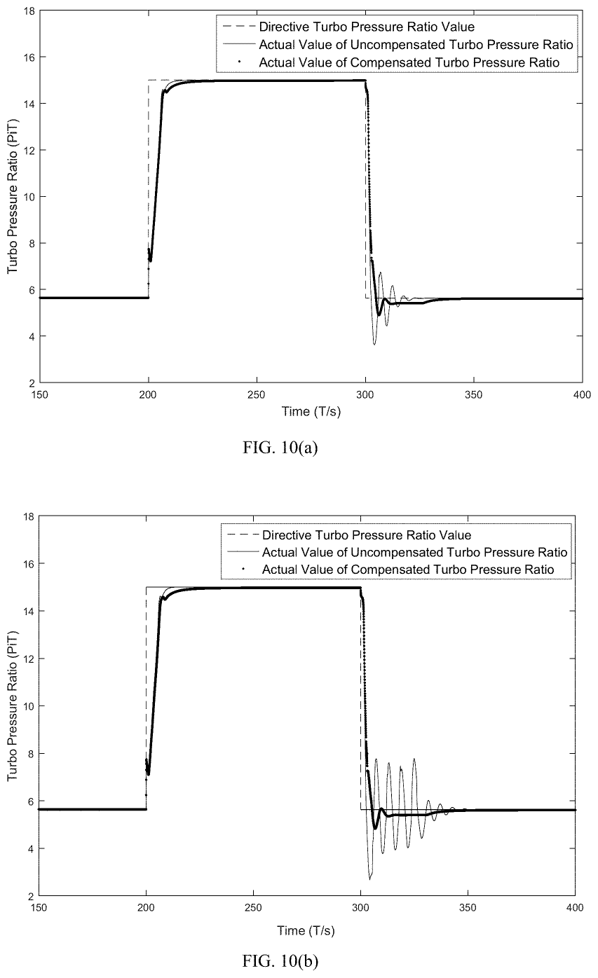

After the design is completed, the control effect of the improved Smith predictive controller-based aero-engine H∞ algorithm is shown in FIG. 9 and FIG. 10. It can be seen from the simulation result that in the presence of different time delays, the improved Smith predictive controller-based aero-engine H∞ algorithm can significantly improve the steady-state performance and dynamic performance of the system, and enhance the robustness of the system. In the simulation experiment, the sampling period of the system is set to 25 ms. As shown in FIG. 9(a), under the condition of 500-ms time delay, during the process of speed increase of the control system adopting the improved Smith predictive controller with dual controllers, the overshoot is 1.3% and the steady-state control accuracy is 0.04%; and during the process of speed decrease, the overshoot is 2.45% and the steady-state control accuracy is 0.11%. As shown in FIG. 10(a), under the condition of 500-ms time delay, during the process of turbo pressure ratio increase of the control system adopting the improved Smith predictive controller with dual controllers, the overshoot is 0 and the steady-state control accuracy is 0.2%; and during the process of turbo pressure ratio decrease, the overshoot is 12.8% and the steady-state control accuracy is 0.27%.

(2) Disturbance Rejection Performance Test

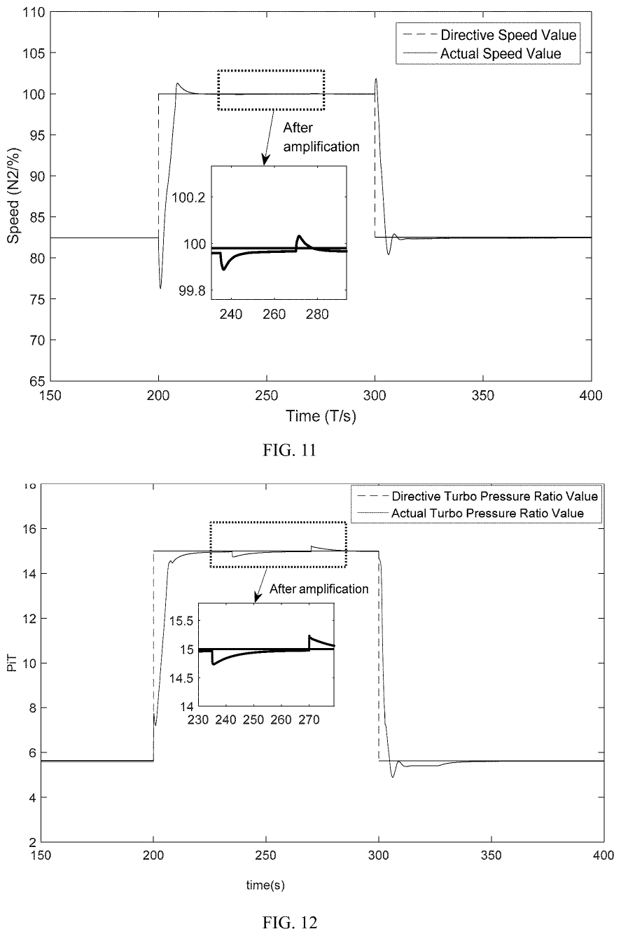

The operation of the improved Smith predictive controller-based aero-engine H∞ control system enables the engine to reach the rated condition. After the control system runs stably, the afterburner fuel oil with the amplitude of 1000 kg/h is applied without changing the controller parameters, and the influence of the disturbance on the performance of the control system is observed and analyzed. The simulation results are shown in FIG. 11 and FIG. 12. The disturbance is applied after the system runs stably, and canceled after 35 s. It can be seen from the figures that during the afterburner process, the speed overshoot is 0.08%, the adjustment time is about 11.4 s, the turbo pressure ratio overshoot is 1.6%, and the adjustment time is about 14.4 s; and during the process of afterburner cancellation, the speed overshoot is 0.03%, the adjustment time is about 12.3 s, the turbo pressure ratio overshoot is 1.8%, and the adjustment time is about 16.2 s.

In conclusion, the improved Smith predictive controller-based aero-engine H∞ algorithm proposed by the present invention is effective and feasible, and can meet the compensation and control requirements for time delay in the aero-engine distributed control system.

1. An improved Smith predictive controller-based aero-engine H∞ algorithm, wherein the controller part in the closed loop of the control system used in the aero-engine H∞ algorithm comprises two parts: the first part is a controller designed with the H∞ control strategy, mainly completing the tracking control on the controlled variable of an aero-engine; and the second part is a time-delay compensation strategy using the improved Smith predictive controller, solving the problem of insufficient adaptability of the aero-engine controller designed according to the H∞ control strategy to the time delay phenomenon;
wherein the H∞ algorithm comprises the following steps:
S1. acquiring the linear model of an aero-engine under a certain operating condition
the engine model is the design basis of the control system; first of all, establishing a reasonable linear model for the aero-engine nonlinear model; based on a multi-variable control target, selecting a high pressure rotor speed and a turbo pressure ratio as controlled variables; the controlled quantities corresponding to the controlled variables are respectively fuel oil and exhaust nozzle area; and the small deviation linear model of the aero-engine under a certain operating condition is expressed by the following state space equation:
$$[ \begin{matrix}Δ {\dot{x}}_{1} \\ Δ {\dot{x}}_{2}\end{matrix} ] = A [ \begin{matrix}Δ {x}_{1} \\ Δ {x}_{2}\end{matrix} ] + B [ \begin{matrix}Δ {W}_{f} \\ Δ {A}_{8}\end{matrix} ] \\ [ \begin{matrix}Δ {N}_{2} \\ Δ PiT\end{matrix} ] = C [ \begin{matrix}Δ {x}_{1} \\ Δ {x}_{2}\end{matrix} ] + D [ \begin{matrix}Δ {W}_{f} \\ Δ {A}_{8}\end{matrix} ] \qquad ( 1 )$$
wherein Δx=[Δx₁ Δx₂]^{T} is a state variable, and Δ\dot{x}=[Δ\dot{x}₁ Δ\dot{x}₂]^{T} is a derivative corresponding to the state variable; Δu=[ΔW_{f} ΔA₈]^{T} is a controlling action, ΔW_{f} is an fuel oil increment output by the controller, and ΔA₈ is an exhaust nozzle area increment; Δy=[ΔN₂ ΔPiT]^{T} is a system output quantity, and ΔN₂ and ΔPiT are respectively the high pressure rotor speed and the turbo pressure ratio; A, B, C, D are engine linear model parameter matrices; and the system identification toolbox provided by Matlab is used to identify a nonlinear model of a twin-shaft turbofan engine to acquire the small deviation linear model of the engine;
S2. designing a multi-variable H∞ controller for the aero-engine nonlinear model
according to the design principle of the multi-variable H∞ controller, selecting appropriate performance index weighting function parameters, solving the H∞ output feedback controller, and adjusting the parameters to meet the control requirements; conducting a multi-variable nonlinear controller test, and finely adjusting each parameter to ensure the overall effect of the turbofan engine so as to enhance the robustness of the multi-variable control system of the turbofan engine;
S2.1. selecting the small deviation linear model acquired through system identification as the nominal model, and regarding the models at other points in the flight envelope as perturbations relative to the nominal model;
S2.2. selecting an appropriate weighting function according to the steady-state control requirements, dynamic control requirements and robustness requirements of engine control indexes. The relationship between the weighting function and the control design indexes is described as follows:
σ̅(S(s))≤σ̅[W_{S}⁻¹(s)] (2)
σ̅(R(s))≤σ̅[W_{R}⁻¹(s)] (3)
σ̅(T(s))≤σ̅[W_{T}⁻¹(s)] (4)
wherein
$$S ( s ) = \frac{e ( s )}{r ( s )} = {( I + G ( s ) )}^{- 1}$$
is the sensitivity function of the control system;
$$T ( s ) = \frac{y ( s )}{r ( s )} = G ( s ) {( I + G ( s ) )}^{- 1} = I - S ( s )$$
is the complementary sensitivity function of the system;
$$R ( s ) = \frac{u ( s )}{r ( s )} = K ( s ) S ( s ) = K ( s ) {( I + G ( s ) )}^{- 1} ,$$
and ∥R(s)∥_{∞} is used to measure the additive perturbations of the system; Wₛ(s) is the performance weighting function; W_{R}(s) is the controller output weighting function; W_{T}(s) is the robust weighting function; G(s) is the original controlled object; and K(s) is the controller;
S2.3. Establishing an augmented controlled object in the following forms:
\dot{x}=Ax+B₁w+B₂u
y=C₁x+D₁₁w+D₁₂u
z=C₂x+D₂₁w+D₂₂u (5)
wherein A, B₁, B₂, C₁, C₂, D₁₁, D₁₂, D₂₁, D₂₂ are model parameter matrices of the augmented controlled object, u is the controlling action, w is the external disturbance, y is the system measurement output signal, and z is the evaluation signal, including tracking error, adjustment error and executive agency output;
the augmented controlled object is expressed as follows:
$$P = [ \begin{matrix}{W}_{s} & - {W}_{s} G \\ 0 & {W}_{R} \\ 0 & {W}_{T} G \\ I & - G\end{matrix} ] = [ \begin{matrix}A & {B}_{1} & {B}_{2} \\ {C}_{1} & {D}_{11} & {D}_{{ }^{12}} \\ {C}_{2} & {D}_{21} & {D}_{22}\end{matrix} ] \qquad ( 6 )$$
wherein P is the augmented controlled object; G is the original controlled object; and Wₛ, W_{R} and W_{T} are respectively the performance weighting function, the controller output weighting function, and the robust weighting function;
S2.4. after constituting the augmented controlled object, selecting appropriate parameters according to the index requirements of the control system, and solving the controller to obtain the H∞ mixed sensitivity controller; the performance indexes meeting the flue mixed sensitivity control problem are:
min∥T_{zw}(s)∥_{∞}<₀(H_{∞} mixed sensitivity optimal control problem) (7)
∥T_{zw}(s)∥_{∞}<γ (H_{∞} mixed sensitivity suboptimal control problem) (8)
wherein T_{zw}(s) is the closed-loop transfer function of the system from external input w to controlled output z; and γ₀,γ are the given values and γ>min∥T_{zw}(s)∥_{∞};
if γ that is not 1 is included in each weighting function, transforming the aero-engine H∞ controller into the standard H∞ control:
$${‖ \begin{matrix}{W}_{s} ( s ) S ( s ) \\ {W}_{R} ( s ) R ( s ) \\ {W}_{T} ( s ) T ( s )\end{matrix} ‖}_{∞} \leq 1 \qquad ( 9 )$$
S2.5. building control system simulation based on the engine linear model, and adjusting the performance index weighting function parameters to basically meet the control index requirements to keep the system in closed-loop stability;
S2.6. conducting a multi-variable nonlinear controller test, and finely adjusting each parameter to ensure the overall effect of the turbofan engine so as to enhance the robustness of the multi-variable control system of the turbofan engine;
S3. designing the Smith predictive controller with an improved structure
according to the basic principle of the Smith predictive controller, based on a closed-loop feedback system designed according to the H∞ control law, designing the Smith predictive controller with an improved structure to constitute a compound controller, and eliminating the exponential term of the network delay that affects the stability of the system from the closed-loop characteristic equation of the system to realize the predictive compensation for the system network-induced delay, enhance the stability of the system and eliminate the need for on-line measurement of the system delay; and in view that the prediction model and parameters of the controlled object have large deviations from the real model and parameters, adding a controller used to stabilize the controlled object to the control system, and making adaptive corrections by comparing the output signals of the controlled object and the model so as to further enhance the robustness of the system.
S3.1. according to the typical structure of the aero-engine distributed control system, analyzing the transfer function of the closed-loop feedback system, and further analyzing the closed-loop characteristic equation;
Closed-loop transfer function:
$$\frac{Y ( s )}{R ( s )} = \frac{K ( s ) {e}^{- {τ}_{ca} S} G ( s )}{1 + K ( s ) {e}^{- {τ}_{ca} S} G ( s ) {e}^{- {τ}_{sc} S}} \qquad ( 10 )$$
closed-loop characteristic equation:
1+K(s)e^{-τ}^{_{ca}}^{s}G(s)e^{-τ}^{_{sc}}^{s}=0 (11)
wherein Y(s) is the system measurement output signal, and R(s) is the reference input signal; K(s) is the controller, and G(s) is the controlled object; and τ_{co} and τ_{sc} respectively represent the network delay of the signal from the sensor to the controller and from the controller to the executor;
S3.2. in view of the inaccuracy of the random and uncertain network delay prediction model, adding some parallel or series links in different positions to make compensation, and under certain conditions, excluding the exponential term of the network delay from the closed-loop characteristic equation;
S3.3. in view that the prediction model and parameters of the controlled object have large deviations from the real model and parameters, regarding the difference between the controlled object and the model as the gain error, making adaptive corrections to model gain by comparing the output signals of the controlled object and the model, and designing a field deviation correction controller for stabilizing the controlled object so as to improve the control performance quality;
S3.4. conducting a compound controller test of an aero-engine time-delay system, finely adjusting each parameter to ensure the speed tracking control effect of the engine to enhance the robustness of the multi-variable control system of the engine and the effectiveness of compensation for time delay.

2. The improved Smith predictive controller-based aero-engine H∞ algorithm according to claim 1, wherein the steps of acquiring the linear model of an aero-engine under a certain operating condition are as follows:
S1.1 saving the data of fuel oil flow and exhaust nozzle area and the corresponding data of high pressure rotor speed and turbo pressure ratio obtained by a certain type of twin-shaft turbofan engine under closed-loop control action;
S1.2. using the saved fuel oil flow and exhaust nozzle area as the input of the nonlinear part-level simulation model of the engine, providing a step signal as an excitation signal to obtain the output of the engine, and using the relevant output parameters as the input and output data for system identification after data processing;
S1.3. based on the Matlab system identification toolbox, importing the input and output data, setting the data name, start time and sampling interval, then removing the average value, selecting the valid range for the input and output data, and selecting the model and the identification method to identify the target system;
S1.4. analyzing the system identification error, verifying the acquired model, and selecting the model that best matches the system characteristics.
